(19) United States
(12) Patent Application Publication
(10) Pub. No.: US 2005/0200846 A1
(43) Pub. Date: Sep. 15, 2005

(54) Ellipsometric measuring process with region-of-interest supported image correction

(76) Inventors: Dirk Hoenig, Goettingen (DE); Kai Sturm, Goettingen (DE)

Correspondence Address: PENDORF & CUTLIFF, 5111 MEMORIAL HIGHWAY, TAMPA, FL, 33634-7356, US

(21) Appl. No.: 11/079,411

(22) Filed: Mar. 14, 2005

(30) Foreign Application Priority Data
Mar. 12, 2004 (DE) 10 2004 012 125.7

(51) Int. Cl. G06K 9/32

(52) U.S. Cl. 356/369; 382/294

(57) ABSTRACT

Image producing ellipsometric measuring process, in which a plurality of individual images, which respectively represent at least one part of an object, are sequentially recorded by means of an image producing detector with varying ellipsometrically relevant recording parameters (102, 108), are stored at least temporarily in a digital memory, and are at least sectionally combined with each other by computation according to pre-set rules for production of an output image or value (126), thereby characterized, that
in a reference image a region of interest (ROI) is defined on the basis of image information parameters and its position and/or shape in a first individual image is determined (104),
in a second individual image the position and/or shape of the ROI is determined (112) on the basis of the same image information parameters,
the second individual image is corrected (122) by translation, rotation, compression and/or stretching at least sectionally in the manner, that the position and/or shape of the ROI in the second individual image corresponds with the position and/or shape of the ROI in the first individual image, and
corresponding image points or regions of the position and/or shape corrected individual images are combined with each other by computation for production of the output image or value (126).

### BACKGROUND OF THE INVENTION

1. Field of the Invention

The invention concerns an image producing ellipsometric measuring process, in which a number of individual images, which respectively represent at least one part of an object, are sequentially recorded under varying ellipsometrically relevant recording conditions using an image producing detector, are stored at least temporarily in a digital memory, and are at least sectionally combined with each other by computation according to preset rules for production of an output image or value.

2. Related Art of the Invention

In this type of process, prior to each recording of each partial image, changes are made for example to the angle of polarization of the light illuminating the object. Other ellipsometrically relevant recording parameters include, for example, wavelength of the illuminating light, angle of incidence, angular setting of a spectrum analyzer preceding the detector, etc. The result is a so-called image-stack of individual images, which images can be at least sectionally combined with each other by computation. Therein it is the objective to correlate with each other respectively those image points or image areas of the individual images which represent the same object point or object region. In the framework of the present application the same object points or object regions representing image points or image regions in the individual images are referred to as corresponding image points or image regions.

The result of a computation of this type can be a computer generated output image, in which values calculated from corresponding image points or regions are encoded in suitable manner as colors or contrast and assigned to the appropriate corresponding image points or regions of the output image. The output image visualizes the spatial distribution of the output values of the individual images. For example, a sample is illuminated with adjustable polarization characteristics on its surface at an angle tilted to the normal angle of the sample, and light reflected from the sample, at a reflection angle likewise angled to the sample normal, is supplied to an image producing polarization sensitive detector device. During measurement one or more illumination and/or detection parameters can be changed. For example, illumination and detection angle, wavelength of the illuminating light, polarization characteristics of the illuminating light, filter characteristics of the polarization sensitive detector device, etc. can be varied. As a rule the variation occurs stepwise, wherein at the conclusion of each variation step one individual image is recorded. The stack of images resulting can then be employed in order, for example, to calculate the ellipsometric values Ψ and/or Δ for each image point or image region and to represent this in the output image.

In another variation the result of the calculation can be an individual value, which is produced from an integrated computation of corresponding image regions in the individual images.

Independent of the special form or mode of the desired result, there frequently occurs the problem of the distortion and/or false positioning of the object in certain individual images in comparison to other individual images. This type of “error” can be of statistical nature or systematic and based upon the applied measuring process. In the field of ellipsometrics there are systematic distortions, when in the framework of a measurement the incident and reflection angles are changed.

### SUMMARY OF THE INVENTION

It is the task of the present invention to further develop the generic process in such a manner that, despite mechanical and/or optical interfering influences (parasitic coupling), interference free output images can be produced.

This task is solved, in association with the characteristics of the precharacterizing portion of Claim 1, thereby, that
in a reference image a region of interest (referred to in the following as “ROI”) is defined on the basis of image information parameters and its position and/or shape is determined in a first individual image,
in a second individual image the position and/or shape of the ROI is determined on the basis of the same image information parameters,
the second individual image is corrected by translation, rotation, compression and/or stretching at least sectionally in the manner, that the position and/or shape of the ROI in the second individual image corresponds with the position and/or shape of the ROI in the first individual image, and
corresponding image points or regions of the position and/or shape corrected individual images are combined with each other by computation for production of the output image or value.

The basic idea of the present invention is that, instead of trusting external position parameters, the position and distortion information is obtained from the partial images, that is, from the image information stored in them. The ROI could in principle correspond with the total individual image, it is however more practical when, as the ROI, essentially well definable, comparatively small image sections are selected. A ROI can be considered to be well definable when certain image information parameters clearly distinguish from other areas of the partial image. As suitable image information parameters there can be considered for example contrast, intensity, color and/or shape information. Thus, for example, an area which exhibits a particular contrast to adjacent image areas can be defined as ROI and be analyzed with respect to shape and position. Reference image and first individual image can be different or the same. The latter is the case, for example, when the first individual image in the framework of a sequence of individual images recorded for measurement is employed as reference image. In a second individual image, then, on the basis of the same parameter, that is, here, the contrast, the same ROI is determined. This can however change with respect to its shape and/or position from the ROI of the first individual image due to optical distortions or mechanical mispositioning. In accordance with the invention an adaptation of the total image occurs until the correspondence of shape and position of the ROIs in the first and second individual image is accomplished.

The adaptation necessary for correspondence of the ROIs can be applied to the total second individual image. Of course, it is however also possible, to employ the adaptation only for a defined segment of the individual image, in particular the ROI itself.

Further individual images are advantageously handled in analogous manner, wherein then as reference image the first recorded reference image or a later recorded individual image, in particular the most recently recorded individual image, can be employed.

For simplification of the ROI definition, the sample can contain so-called markers, which are applied during sample preparation and differentiate from the remaining sample in significant manner, for example by color, shape, degree of reflection, etc. Alternatively, or in addition, known characteristics of the illumination light can be employed for defining the ROI. It is for example known to direct the illumination light from the illumination lens to a stripe-shaped area of the sample, then the ROI can be defined as an approximately stripe shaped contiguous region between two boundary lines, which are defined by a (relative or absolute) illumination intensity threshold value.

In an advantageous embodiment of the invention an edge search image processing algorithm, which is based on a relevant image information parameter, can be applied to the individual image for determining the position and/or the shape of the ROI in an individual image. In this manner a binary intermediate image is produced from each individual image and the shape and/or position adaptation process occurs on the basis of the binary images. The result of the adaptation or conformance process can then be applied to the original individual images. This has the advantage, that on the basis of particularly small amount of data from binary images the adaptation process can be carried out with particularly low computation complexity and thus particularly rapidly.

In image producing ellipsometrics a contrast inversion of those image information parameters which are particularly suited for definition in a ROI can occur within a sequence of individual images recorded in the framework of the measurement. If, for example, a spatially limited coating of bio-molecules on a substrate is to be ellipsometrically examined, then certain angles, wavelengths or polarization settings can lead to a contrast maximization between coating and carrier substrate, while other angles, wavelengths or polarization settings can lead to a contrast minimization or to a complete disappearance of the contrast. If in the framework of the measurement the appropriate measurement parameters are carried out, wherein for various settings respectively one individual image is recorded, thereafter one or more partial images exhibit a minimized or disappearing contrast. If previously however the ROI is defined on the basis of this contrast, then the inventive process comes up against a problem, when the contrast minimized individual image is employed as second individual image in the sense of Claim 1.

One advantageous further embodiment of the invention can accomplish, by working around or remedying, that, with use of the position and/or shape of the ROI determined in the first individual image and the position and/or shape of the ROI determined in the second individual image, a position and/or shape correction interpolated or extrapolated to a third individual image (direct or indirect). This means, that as second individual image a further individual image is employed, in which the value of the ROI defining image information parameter is suited, for determining the ROI therefrom. The shape and position of the ROI in the third (for example, contrasting minimized) individual image can then be determined by interpolation between the first and second individual image or by extrapolation from the first and second individual image. Preferably one employs individual images adjacent to the third individual image as support points for the interpolation or extrapolation. Alternatively, the correction parameters to be applied to the first and second individual images can first be calculated and therefrom the correction parameter to be applied to the third individual image can be interpolated or extrapolated.

Besides a simple linear interpolation or extrapolation it is also possible to employ complicated interpolation or extrapolation processes when, for example, a systematic dependency of the image distortion is known to depend from experimental conditions. This could for example be the case for the changing of the angle of incidence of the illumination light and the corresponding reflection angle in the framework of an ellipsometric measurement. In an advantageous embodiment of the inventive process it can be provided that the combining of multiple individual images or sections thereof by computation includes a mathematical operation which is applied to a sequence of data which represents averaged values of image points which belong to ROIs corresponding to each other in multiple positions and/or shape-corrected individual images. This means that integrated values concerning certain image areas can be employed as data units to be processed with each other. This process is suited particularly to low light applications, in which the relative noise can be reduced during combining of multiple image points by computation.

In order to avoid the problem that a suboptimal shape and/or position correction of the individual images or ROIs to be combined with each other by computation leads to excessive errors at the edge of the ROIs, it be provided in an advantageous further embodiment of the above process variant that, in the averaging of image point values in each individual image, only those image points are taken into consideration which have or exceed a predefined minimum separation to the outside border of their respective ROI. In other words, only an internal area of the ROI is drawn upon for averaging, while the critical edge area of the ROI is left out. In the definition of the ROIs it is possible to define either a single contiguous area as a ROI or also multiple, non-contiguous areas of a ROI. Therein it can be advantageous when a ROI defined on the basis of image information parameters can be modified by manual interaction via a graphic user interface section or point. Thus, for example, the abstract definition of the ROI can, on the basis of certain image information parameters, lead to a ROI which is comprised of a plurality of non-contiguous image regions, of which however only one or a few are of interest in the actual measurement. If then the first individual image, serving as definition reference for the ROI, is presented on a monitor, then the user in this embodiment has the possibility, by fundamentally known actions in the framework of a graphic user interface, to modify the ROI definition in a measurement optimizing manner.

A further problem can occur when the optical and/or mechanical errors, which lead to a distortion and/or mispositioning, are so large, that the ROI defined in the first individual image cannot be detected in the second individual image, since it is not contained completely within the boundaries of the second individual image. An advantageous further embodiment of the inventive process provides, in this case, that this individual image is discarded and an alternative individual image is recorded and is used as the basis for further processing, wherein prior to recording the alternative image an automatic repositioning of the object occurs, so that the ROI to be detected in the alternative individual image lies completely within the alternative individual image. The process thus recognizes automatically, that the false positioning is so large, that the ROI to be detected lies at least partially outside of the boundaries of the individual image. By suitable image dynamic algorithms, which are fundamentally known to the person of ordinary skill, on the basis of the part of the ROI remaining within the boundaries of the second individual image, the error in positioning can be determined. By suitable compensatory repositioning of the sample relative to the recording lens then a new image can be recorded, with which the process can be continued in the intended manner.

An advantageous further embodiment of the inventive process envisions that a mathematic operation is applied on the basis of the sequence of data, which represents the values of associated corresponding image points in multiple associated total images. One example for this would be, for instance, to determine the values Δ and Ψ, from a multiple of individual images, which respectively are comprised of a plurality of individual images, which for example result from successive illuminations and recordation of partial regions of the sample.

In advantageous manner the partial images are corrected in accordance with the basic principle of the present invention prior to combining by computation. This means in particular, that
a region of interest (ROI) is defined in a reference image on the basis of image information parameters and it's position and/or shape is determined in a first partial image,
in a second partial image the position and/or shape of the ROI is determined on the basis of the same image information parameters, and
the second partial image is corrected by translation, rotation, compression and/or stretching at least sectionally in the manner that the position and/or shape of the ROI in the second partial image corresponds with the position and/or shape of the ROI in the first partial image.

### BRIEF DESCRIPTION OF THE DRAWING

Further advantages of the invention can be seen from the following specific description and the figures, in which

FIG. 1: shows a simplified flow diagram of an advantageous embodiment of the inventive process,

FIG. 2: shows a schematic representation of an image stack,

FIG. 3: shows a schematic representation for overview of the inventive interpolation,

FIG. 4: shows a schematic representation for clarification of object distortion,

FIG. 5: shows a schematic representation for clarification of object migration, and

FIG. 6: shows a schematic representation for use of the inventive process in an ellipsometric measuring device.

### DETAILED DESCRIPTION OF THE INVENTION

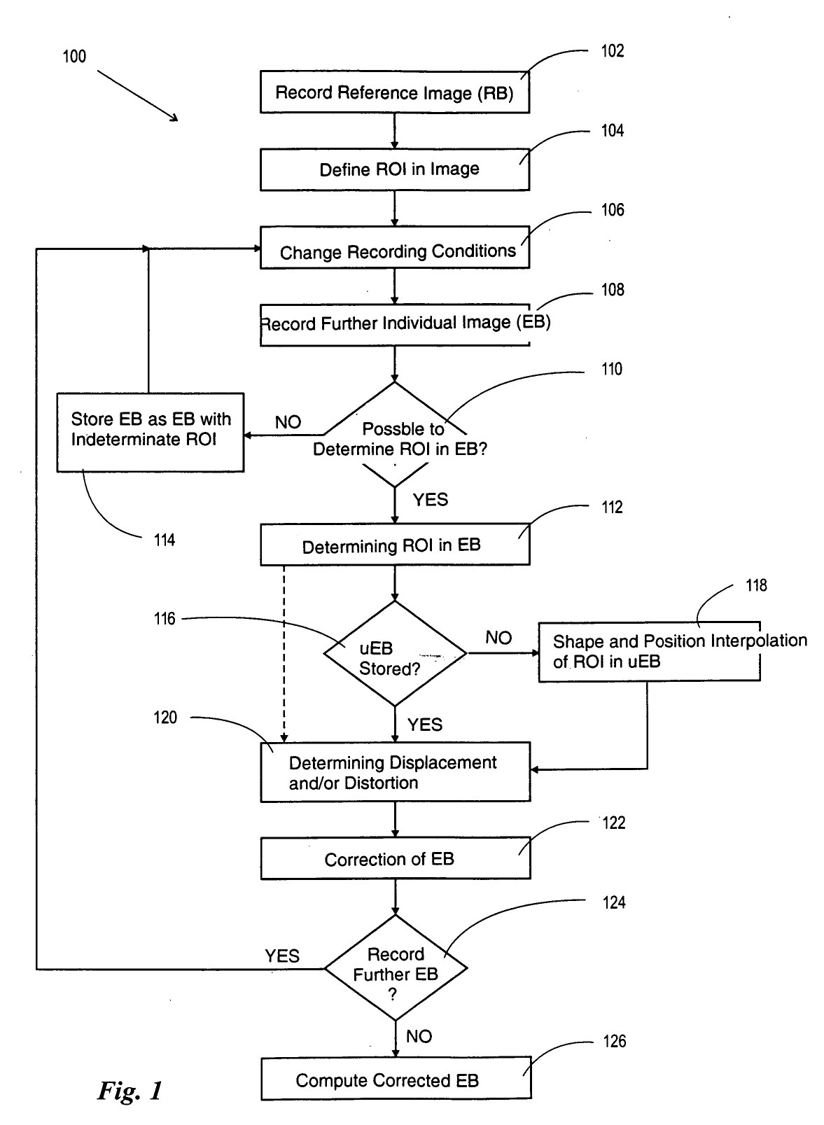

FIG. 1 represents in a flow diagram 100 a particularly preferred embodiment of the inventive process. For purposes of overview the representation occurs schematically and strongly simplified. Several possible variations will likewise be described in the framework of the description of FIG. 1.

First, in step 102 a reference image (RB) is recorded. As reference image there is particularly suited the first individual image recorded and stored in the framework of a sequence of individual images to be recorded for a measurement. Alternatively a separate reference image can be recorded which is independent of the actual measurement, for example, on the basis of a particular reference sample.

In this recorded reference image then in step 104 at least one region of interest (ROI) is identified on the basis of the image information parameters contained in the reference image and specified with respect to its position and shape. As image information parameters there may be suited for example a particular contrast. The actual definition process can, depending upon the embodiment of the invention, occur variously. One possibility is to carry out a definition automatically on the basis of pre-defined threshold values for relevant information parameters, for example, by the computer used in carrying out the process. In one advantageous further development of this variant the determined ROI is displayed to the user in the reference image and he is given the opportunity, via a graphic user interface, to undertake modifications of the automatically defined ROI. Another variation for ROI-definition is, on the basis of the displayed reference image, first manually to mark image areas of interest via a graphic user interface. The computer can then determine commonalities of the marked image areas and/or differences with regard to the not marked image areas, and from this produce a ROI definition as a function of relevant image information parameters. Besides threshold values, which could be of a relative to an absolute nature, it is possible also to use other characteristics of the relevant image information parameters for definition of the ROI. Examples for this could be, for instance, separations, contiguous surfaces, structures, closed lines, etc. As the result step 104 provides a definition of a ROI as a function of certain image information parameters.

In the following step 106, as preparation for recording a further individual image (EB) in step 108, the conditions for the recording of the further individual image are changed. In an ellipsometric measurement these changes could be the incidence or reflection angle, the wavelength, the polarization characteristics of the illuminating light or the adjustment of an analyzer in the detection beam path. It is also possible, for example, prior to recording the next individual image, to displace the sample itself relative to the detection lens or the illumination object in such manner that other sample areas are illuminated.

Following the recordation of the further individual image in step 108 it is determined in step 110 whether a determination of the ROI according to the definition established in step 104 is possible in the new individual image. If no ROI can be detected in the newly recorded individual image (for example due to the fact that a particular contrast is passing through a zero phase due to changes in the recording conditions in the newly recorded individual image, that is, the contrast disappears), then this individual image is intermediate stored in step 114 as an individual image with undetermined ROI (uEB) and the process returns back to step 106, where the preparation for the recording of a further individual image is met. On the other hand, in step 112 the determination of the ROI in the actual individual image is carried out.

In a particularly simple embodiment of the invention, which is indicated as a dashed arrow in FIG. 1, immediately after determining the ROI (step 112) in step 120 the displacements and/or distortions are determined. This occurs in a first pass-through of the process by comparison with the reference image RB recorded in step 102 or, as the case may be, with the ROI determined in step 104. In further pass-throughs of the process, that is, in the processing of further individual images, then once again reference can be made to the reference image RB. Alternatively the displacement and/or distortion in the actual individual image can be determined also by comparison with a previous (valid) individual image or, as the case may be, the ROI therein can be determined. On the basis of the determined displacement and/or distortion then in step 122 a correction of the actual individual image or a segment thereof (for example the ROI) can be undertaken.

If further individual images are to be recorded, which is determined in step 124, then the process returns to step 106. If on the other hand no additional individual images are to be recorded, then the corrected individual images can, in step 126, each be combined with each other by computation according to task assignment, for instance by employment of a mathematical operation for corresponding pixels of an individual image stack or by combining by computation of multiple individual images from partial images into a total image.

In a somewhat more complicated variation of the process, which is however more advantageous when in the course of the measurement null pass throughs of relevant image information parameters are to be expected, then subsequent to the determination of the ROI in step 112 it is determined in step 116 whether individual images with undeterminable ROI are to be intermediate stored. If this is not the case, then the process sequence transitions to the above described step 120. If however individual images with indeterminate ROI are intermediate stored, then there occurs in step 118 a shape and/or position interpolation of the ROI in the intermediate stored individual image. This means, that the shape and/or the position of the ROI in the intermediate stored individual image is estimated with the aid of at least one determined ROI in a previously recorded individual image and at least one determined ROI in an individual image recorded subsequently to the intermediate stored image. This estimation then replaces the previously ROI which had been evaluated as impossible-to-recognize in the intermediate stored individual image and the process precedes to step 120, where the individual image with interpolated ROI is treated like a regular individual image with determined ROI.

Alternatively to the interpolation explained with reference to FIG. 1 an indeterminable ROI can also be determined by means of an extrapolation, wherein for estimation multiple individual images recorded prior or subsequent to the critical individual image are drawn upon or considered. It is to be noted that the expression “prior” and “subsequent” in this context need not be understood as being necessarily with regard to time. Rather it is to be understood with regard to the behavior of the relevant image information parameters as a function of the change of the recording conditions. As an example, one could consider contrast, which may first be declining, then disappearing and finally increasing during monotone passing through of the polarization angle in an ellipsometric measurement.

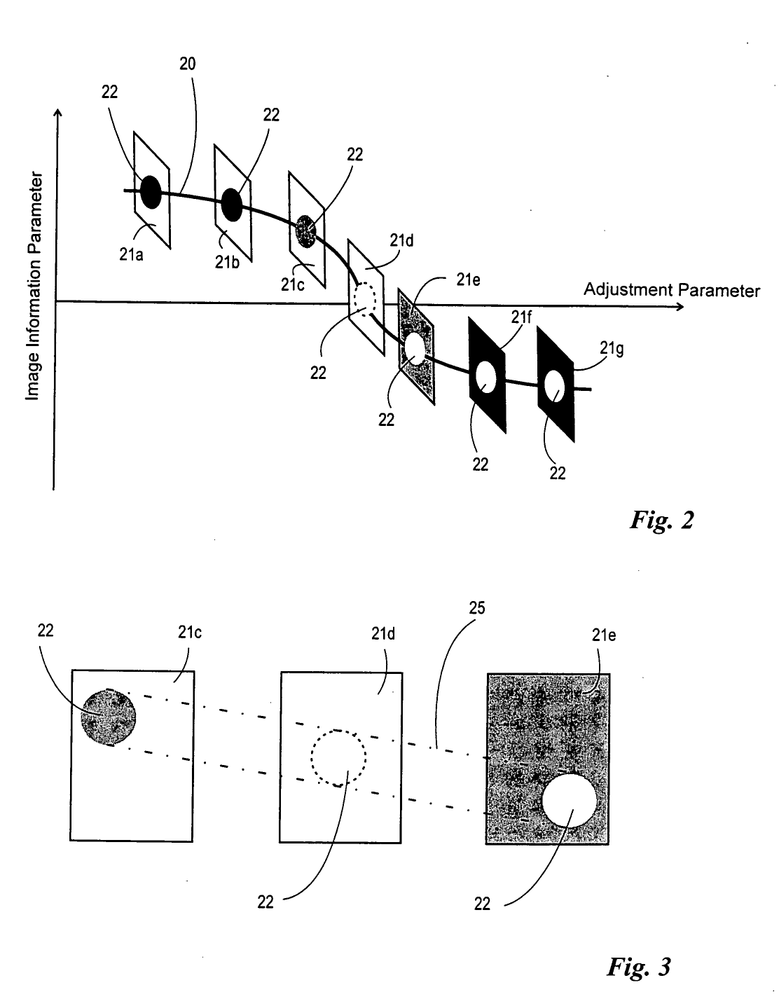

For overview FIG. 2 schematically shows an image stack on a likewise schematic graph of an image information parameter (for example contrast, as indicated in FIG. 2) as function of an experimental adjustment parameter. Contrast experiences in this example in the individual image 21d a null pass, so that the circular shaped represented ROI 22 is not determinable in this individual image. FIG. 3 then shows the inventive interpolation, wherein it is assumed, that from individual image to individual image essentially one sample change occurs without distortion. The position of the ROI 22 can in the individual images 21c and 21e, which exhibit a sufficient contrast, be exactly determined. In the preceding case the position of the non-determinable ROI 22 in individual image 21d is determined by linear interpolation. Of course, other complex interpolations or extrapolation processes are conceivable.

In the shown illustrative example the shape or as the case may be position of a not determinable ROI is estimated, and from this the suitable correction for the appropriate individual image is calculated. On the other hand, a direct interpolation of the correction parameter is also possible. This means, that first in the individual images with determinable ROI the necessary correction is determined in the sense of translation, rotation, compression and/or stretching parameters and these parameters are extrapolated for correction of the individual image with not determinable ROI are interpolated or extrapolated. Both process variants are intended to include the here employed expression of the (indeterminable or as the case may be intermediate) interpolation or as the case may be extrapolation of a position and/or shape correction to be applied.

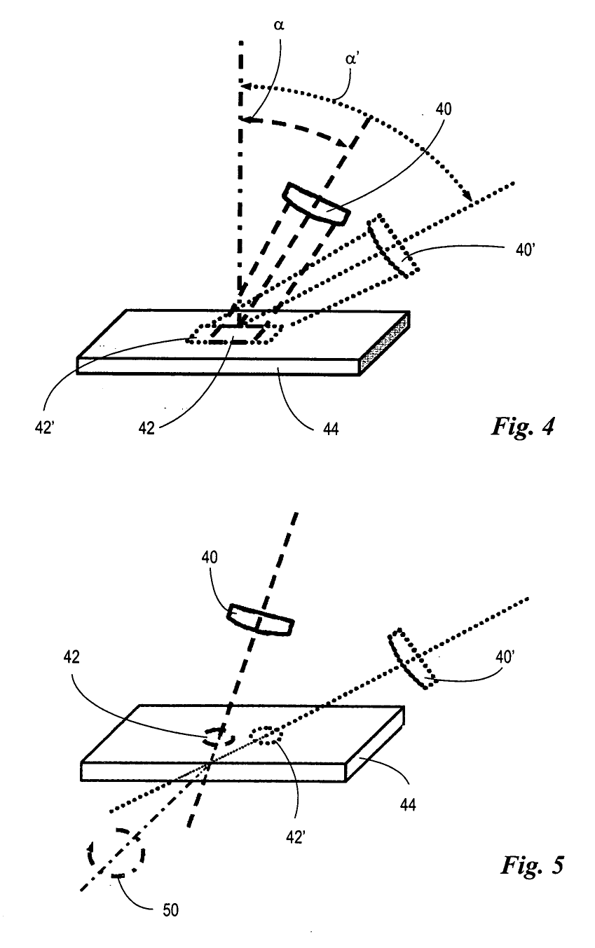

FIGS. 4 and 5 schematically show possible ramifications or effects of the changes of a relative angle α or as the case may be α′ of a detection lens 40 or as the case may be 40′ in relationship to a sample region 42 or as the case may be 42′, which is applied on a carrier substrate 44 as part of a thin layer. FIG. 4 illustrates the resulting distortion, while FIG. 5 illustrates an apparent sample movement. The apparent sample movement occurs due to the fact that the actual rotation axis, about which the angle a and a′ rotate, lies below the sample surface to be examined, as indicated in FIG. 5 by the rotation arrow 50. With regard to the inventive process the apparent object movement shown in FIG. 5 is comparable to an actual object movement.

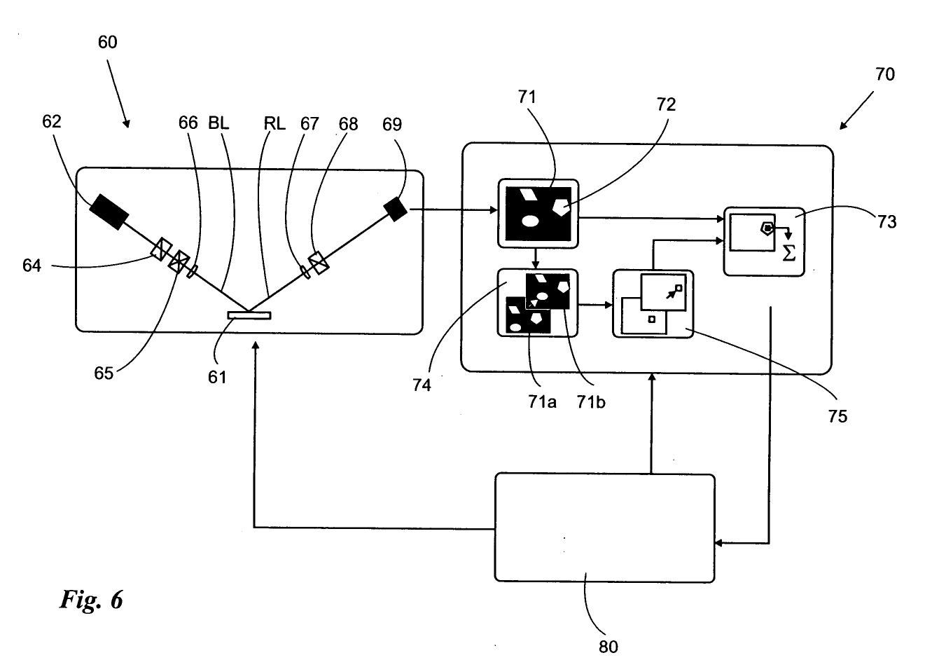

FIG. 6 schematically shows a device for ellipsometric measurement of a sample with use of the inventive process. In an ellipsometer 60 a sample 61 is illuminated by means of a light source 62, preferably a laser, with illumination light BL having adjustable position characteristics. Preferably one employs for this a polarizer 64, a subsequent compensator 65 and a suitable illumination optics or lens 66. The sample 61 is illuminated by the illumination light BL at an angle tilted relative to the sample norm. Accordingly there results a reflection angle tilted relative to the sample norm at which reflection light RL from sample 61 impinges via a suitable imaging lens 67 and an analyzer 68 on an image producing detector 69.

Imaging lens 67, analyzer 68 and image providing detector 69 can be integrated as a polarization sensitive detection unit. The individual images 71 recorded by the detector 69 are at least intermediate stored in an image processing system 70, which can be embodied as an individual module or imbedded in a complex system. In the illustrated embodiment a five-sided surface is employed as ROI 72, wherein, as indicated in the box 73, the sum of the image points contained in this surface are relevant for further evaluation. As shown in box 74, in sequential recorded partial images 71a and 71b, first the ROIs are determined and therefrom the relative displacement of the individual images 71a and 71b are determined. These displacements can be corrected by a suitable compensation algorithm (box 75), so that for the desired computation, namely the above-mentioned sum or total image, the correct image points, namely those associated with the respective ROIs, can in suitable manner be combined with each other by computation. Preferably the control of the measuring device, the control of the image processing process and the subsequent data evaluation occurs via a computer 80.

Of course, the illustrated embodiments of the present invention explained with regard to the figures and the special description should be understood to be merely illustrative examples. In particular the design of the special measuring apparatus, the sequence of individual process steps and the concrete programming of necessary algorithms can be varied on the basis of the present description depending upon the precise objective.

1. An image producing ellipsometric measuring process, in which a plurality of individual images, which respectively represent at least one part of an object, are sequentially recorded by means of an image producing detector with varying ellipsometrically relevant recording parameters (102, 108), are stored at least temporarily in a digital memory, and are at least sectionally combined with each other by computation according to pre-set rules for production of an output image or value (126), wherein
in a reference image a region of interest (ROI) is defined on the basis of image information parameters and its position and/or shape in a first individual image is determined (104),
in a second individual image the position and/or shape of the ROI is determined (112) on the basis of the same image information parameters,
the second individual image is corrected (122) by translation, rotation, compression and/or stretching at least sectionally in the manner, that the position and/or shape of the ROI in the second individual image corresponds with the position and/or shape of the ROI in the first individual image, and
corresponding image points or regions of the position and/or shape corrected individual images are combined with each other by computation for production of the output image or value (126).

2. The process according to claim 1, wherein the information parameters include one of contrast, intensity, color and/or ape information.

3. The process according to claim 1, wherein for determining the position and/or shape of the ROI in an individual image, an edge search image processing algorithm is employed on the individual image.

4. The process according to claim 1, wherein using the position and/or shape of the ROI determined in the first individual image and the position and/or shape of the ROI determined in the second individual image a position and/or shape correction to be applied to a third individual image is interpolated (118) or extrapolated.

5. The process according to claim 1, wherein the combination of multiple individual images or segments thereof by computation includes a mathematical operation, which is applied to a sequence of data, which corresponds to averaged or summed values of image points, which belong to ROIs corresponding to each other in a plurality of position and/or shape corrected individual images.

6. The process according to claim 5, wherein in the averaging or summing of image point values in each individual image, only those image points are taken into consideration which have or exceed a predefined minimum separation or spacing to the outer border of their respective ROI.

7. The process according to claim 1, wherein the ROI is comprised of multiple, not contiguous image regions.

8. The process according to claim 1, wherein a ROI defined on the basis of image information parameters is modified by manual interaction via a graphic user interface.

9. The process according to claim 1, wherein in the case that a ROI to be detected in an individual image is not contained completely within the boundaries of the individual image, this individual image is discarded and an alterative individual image is recorded and is used as basis for further processing, wherein prior to recording the alternative individual image an automatic repositioning of the object occurs, so that the ROI to be detected in the alternative individual image completely lies within the alternative individual image.

10. The process according to claim 1, wherein each individual image is comprised of a plurality of partial images, wherein prior to putting together the partial images
a region of interest (ROI) is defined in a reference image on the basis of image information parameters and its position and/or shape is determined in a first partial image,
in a second partial image the position and/or shape of the ROI is determined on the basis of the same image information parameters, and
the second partial image is corrected by translation, rotation, compression and/or stretching at least sectionally in the manner that the position and/or shape of the ROI in the second partial image corresponds with the position and/or shape of the ROI in the first partial image.

11. The process according to claim 1, wherein between the recording of two individual images respectively an angle of incidence of the illumination light, the spectral composition thereof and/or the polarization characteristics thereof is changed.

12. The process according to claim 10, wherein between the recording of two individual images respectively an angle of incidence of the illumination light, the spectral composition thereof and/or the polarization characteristics thereof is changed.
